(19) United States
(12) Patent Application Publication
(10) Pub. No.: US 2008/0133375 A1
(43) Pub. Date: Jun. 5, 2008

(54) Method, System and Apparatus for Facilitating Selection of Sellers in an Electronic Commerce System

(76) Inventor: Alex Henriquez Torrenegra, Secaucus, NJ (US)

Correspondence Address: GORDON & JACOBSON, P.C., 60 LONG RIDGE ROAD, SUITE 407, STAMFORD, CT, 06902, US

(21) Appl. No.: 11/947,222

(22) Filed: Nov. 29, 2007

Related U.S. Application Data
(60) Provisional application No. 60/872,074, filed on Dec. 1, 2006.

(51) Int. Cl. G06Q 30/00

(52) U.S. Cl. 705/26

(57) ABSTRACT

An improved system and method for facilitating a transaction between a buyer and one of a number of sellers is provided. The transaction is related to a project specified by the buyer. A set of invited sellers suitable for the project are identified. Such invited sellers can be identified by an automated process that matches sellers registered by the system to the project, buyer selection of a seller registered by the system, and/or buyer selection of a seller not registered by the system. Invitations for submission of an offer for the project are communicated to the set of invited sellers for the project, and offers from the invited sellers are electronically submitted to the system.

### CROSS-REFERENCE TO RELATED APPLICATIONS

This application claims benefits from U.S. Provisional Patent Application No. 60/872,074, filed Dec. 1, 2006, the contents of which are hereby incorporated herein by reference.

### BACKGROUND OF THE INVENTION

1. Field of the Invention

This invention relates broadly to methods, systems and apparatus for facilitating electronic commerce. More particularly, this invention relates to methods, systems and apparatus for facilitating selection of sellers of goods and services in an electronic commerce system.

2. State of the Art

Electronic commerce systems (such as online marketplaces, online auction houses, online reverse auction houses) provide a mechanism for connecting sellers with buyers for facilitating transactions related to goods and services. For reverse auctions, there can be a significant number of potential sellers that can meet the demands of a respective buyer. This unbalance can have negative effects such as:
too much competition among sellers;
an overflow of offers submitted from sellers to a respective buyer and a low conversion ratio of acceptance of such offers by buyers;
a reduced quality of offers submitted from sellers to a respective buyer; and
a perception by the sellers who submit offers that the lowest priced offer will be accepted by the buyer.

Currently, electronic commerce systems only allow sellers from that are registered and stored in database of the electronic commerce system to submit offers to a buyer. This has negative effects such as:
the buyer may not find an appropriate or acceptable seller registered and stored in the database of the electronic commerce system; and
the buyer cannot easily compare offers submitted by sellers registered and stored in the database of the electronic system with other non-registered sellers.

### In this manner, the prior art electronic commerce system limit the participation of potentially qualified sellers and, by doing so, fail to provide potentially valuable services to buyers and thus diminish the value of such systems to buyers.

Thus, there remains a need in the art for improved methods, systems and apparatus for facilitating electronic commerce involving buyers and sellers of good and services.

### SUMMARY OF THE INVENTION

It is therefore an object of the invention to provide improved methods, systems and apparatus for facilitating electronic commerce involving buyers and sellers of good and services.

It is another object of the invention to provide such methods, systems and apparatus where connecting buyers and sellers is part of a reverse auction process.

It is a further object of the invention to provide mechanisms for selection of sellers that is effective when there are a significant number of sellers that can meet the demands of a respective buyer.

It is yet another object of the invention to provide mechanisms for receiving offers from sellers that can meet the demands of the respective buyer.

In accord with these objects, which will be discussed in detail below, an improved system and method for facilitating a transaction between a buyer and one of a number of sellers is provided. The transaction is related to a project specified by the buyer. A set of invited sellers suitable for the project are identified. Such invited sellers can be identified by an automated process that matches sellers registered by the system to the project, buyer selection of a seller registered by the system, and/or buyer selection of a seller not registered by the system. Invitations for submission of an offer for the project are communicated to the set of invited sellers for the project, and offers from the invited sellers are electronically submitted to the system.

In the preferred embodiment, the systems and methods provide for electronic submission of offers from invited sellers that are registered by the system as well as electronic submission of offers from invited sellers that are not registered by the system.

In an illustrative embodiment, the systems and methods enable the buyer to select one or more sellers not registered by the system. The buyer communicates to such non-registered sellers invitations for submission of an offer for the given buyer's project. These invitations preferably include a project URL and an optional project access code. The non-registered seller(s) use the project URL to access the system to initiate registration of the seller(s) on the system. The project access code is used to confirm that the seller accessing the system was in fact invited by the buyer. Once registered, the seller is classified as an invited seller for the given buyer's project and the seller is granted access to the system for electronic submission of an offer for the buyer's project and tasks related thereto.

Additional objects and advantages of the invention will become apparent to those skilled in the art upon reference to the detailed description taken in conjunction with the provided figures.

### BRIEF DESCRIPTION OF THE DRAWINGS

FIG. 1 is a block diagram of an electronic commerce system that includes functionality for connecting buyers and sellers of good and services in accordance with the present invention.

FIGS. 2A and 2B, collectively, is a flow chart illustrating the operations of the electronic commerce system of FIG. 1 in accordance with the present invention.

FIGS. 3A1, 3A2, 3B, 3C1 and 3C2 illustrate exemplary user interfaces generated by the system of FIG. 1 for creating and managing projects and perform related tasks where voice over talent or producers provide voiceovers to buyers for commercial needs.

FIGS. 4A, 4B, 4C1, 4C2, 4D1, 4D2, 4E, 4F1, 4F2 and 4F3 illustrate exemplary user interfaces generated by the system of FIG. 1 that present invitations to voice over talent and producers (Sellers) for offers related to Buyers' project(s) and that allow such Sellers to electronically submit and manage offer(s) and perform other tasks related to the Buyers' project(s).

### DETAILED DESCRIPTION OF THE PREFERRED EMBODIMENTS

For purposes of description herein, a “reverse auction” is a process whereby a number of sellers compete for the right to provide goods or services to a buyer. The reverse auction is different from an “ordinary auction,” which is process whereby a number of buyers compete for the right to obtain goods or services from a seller.

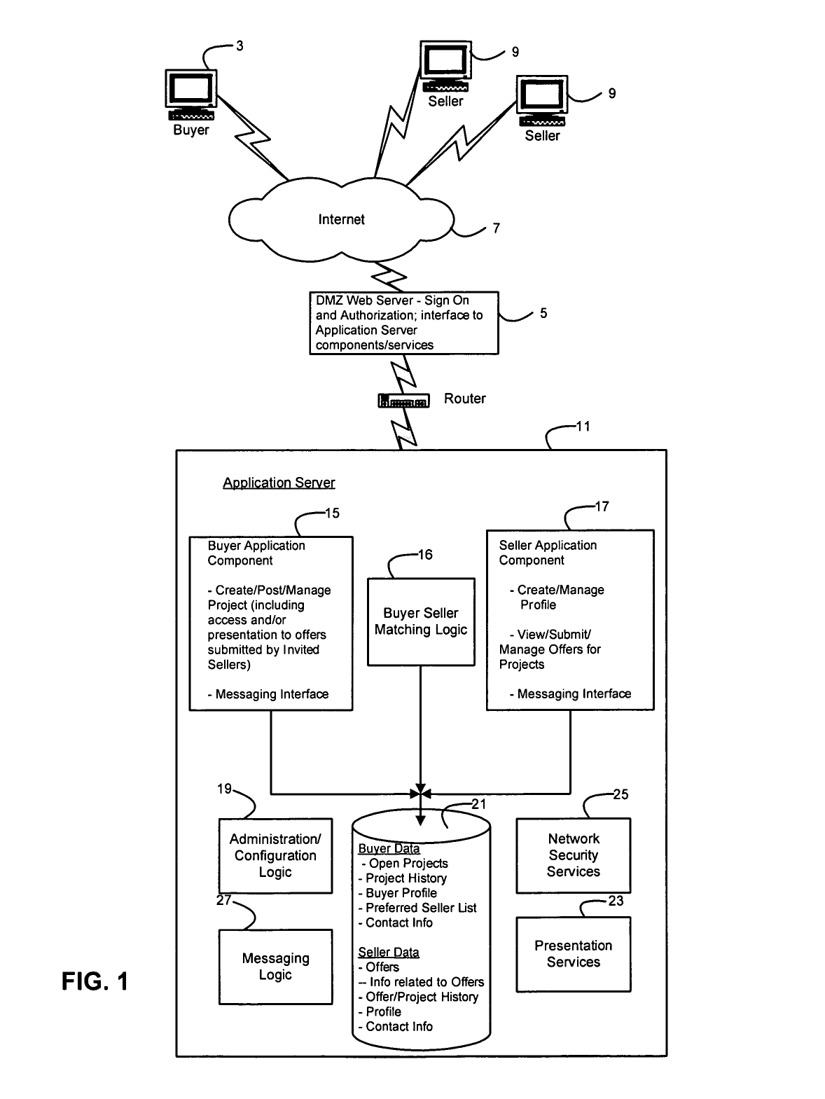

Turning now to FIG. 1, there is shown the architecture of an electronic commerce system that facilitates reverse auctions. There are two classes (denoted “Buyers” and “Sellers”) of users of the system. One or more Buyers access the system over a network (such as the Internet) to create and manage projects. A project is a solicitation for goods and/or services that are desired by the Buyer. Sellers of the system compete for the right to provide goods or services to a Buyer as dictated by a corresponding project. In the illustrative embodiment, a project involves a number of requirements, such as one or more dates related to the project (e.g., a start date and/or an end date) and specific needs or functions to be provided by the Seller to the Buyer. Sellers access the system over the network to register and maintain a profile stored on the system. The system includes i) software logic that automatically matches a number of Sellers to a given Buyer's project that is posted or otherwise designated by the given Buyer, and ii) software logic that enables the given Buyer to select one or more Sellers registered by the system for the given Buyer's project. The Sellers that are matched and/or selected by such software logic are classified as Invited Sellers for the given Buyer's project. The system includes software logic for communicating to the Invited Sellers invitations for submission of an offer for the given Buyer's project. The system includes software logic for enabling electronic submission of offers and related tasks by the Invited Sellers for the given Buyer's project. The system also provides for communication and management of such offers between Buyers and Sellers in order to facilitate transactions therebetween.

The Buyer can also select one or more Sellers not registered by the system and communicate to such non-registered Sellers invitations for submission of an offer for the given Buyer's project. These invitations preferably include a project URL and an optional project access code. The non-registered Seller(s) use the project URL to access the system to initiate registration of the Seller(s) on the system. The project access code is used to confirm that the Seller accessing the system was in fact invited by the Buyer. One registered, the Seller is classified as an Invited Seller for the given Buyer's project and the Seller is granted access to the system for electronic submission of an offer for the Buyer's project and tasks related thereto.

As shown in FIG. 1, a Buyer utilizes a web browser executing on a computing device 3 to connect to a web server 5 over the network 7 (e.g., Internet). Similarly, a number of Sellers each utilize a web browser executing on a computing device 9 to connect to the web server 5 over the network 7. Preferably, the browser-based interaction between the computing devices 3, 5 and the web server 5 occur over TCP/IP sessions established therebetween over which are communicated HTML-based (and possibly XML-based) documents and commands as well as other messages, commands and data. The web server 5 enables login and authentication of the Buyer via interaction with the Buyer system 3 as well as login and authentication of a respective Seller via interaction with the Seller system 9. Such login and authentication can utilize password-based authentication, operating system-based authentication (e.g., NTLM or Kerberos); services-based authentication (e.g., Microsoft Passport authentication), certificate-based authentication, or any other authentication scheme. Once a user session has been authorized (whether it be a Buyer session or Seller session), the web server 5 communicates with an Application Server 11 to build dynamic web page(s) based on data supplied by the Application Server 11 and serve the dynamic web page(s) to the Buyer web browser (or the Seller web browser) as requested, and forward (and/or transform) data supplied by the Buyer web browser (or the Seller web browser) to the Application Server 11 as needed. Preferably, the web server 5 is located in a “demilitarized zone” (DMZ) provided with a firewall router 13. In this configuration, the firewall/router 13 enables authorized communication between the web server 5 and the Application Server 11 (typically utilizing a secure socket layer (SSL) interface or an IPSec interface), while blocking unauthorized communication requests to the Application Server 11. In addition, the web server 5 preferably utilizes style sheets to build the HTML documents (and XML documents) for presentment to the Buyer web browser (or to the Seller web browse). The web server 5 may be realized by commercially available HTTP servers, such as the Apache Web Server, Microsoft Internet Information Server, and Sun ONE Web Server.

The Application Server 11 includes a Buyer Application Component 15, a Seller Application Component 17, Buyer Seller Matching Logic 16, Administration/Configuration Logic 19, a Database 21 storing buyer data and seller data, Presentation Services 23, Network Security Services 25, and Messaging Logic/Services 27. The Administration/Configuration Logic 19 provides for system management and configuration of the Application Server 11. The Presentation Services 23 are facilities that enable delivering dynamic content to client browsers. Preferably, the Presentation Services 23 support Active Server Pages, JavaServer pages, server-side scripting such as Perl, CGI, PL/SQL scripting, etc. The Network Security Services 25 provides facilities that enable maintaining network security (such as SSL-based or IPSec-based encryption and authentication facilities). Preferably, the Application Server 11 is realized by a commercially-available software framework, such as the WebLogic Platform commercially available from BEA Systems of San Jose, Calif., the Websphere Application Server commercially available from IBM, Windows Server Systems commercially available from Microsoft Corporation of Redmond, Wash., or the SUN ONE Application Server commercially available from Sun Microsystems of Santa Clara, Calif.

The Database 21 maintains buyer data that pertains to a respective Buyer and to the projects of the respective Buyer as well as seller data that pertains to a respective Seller and to the offers of the respective Seller. In the illustrative embodiment shown, the buyer data pertaining to a respective Buyer can include data defining open projects, project history, profile of the respective Buyer, a preferred seller list, contact information for the respective Buyer, etc. The seller data pertaining to a respective Seller can include defining offers to which the respective seller has been matched (i.e., offers for which the Seller is classified as an Invited Seller), information related to such offers, offer/project history, profile of the respective Seller, contact information for the respective Seller, etc.

The Buyer Application component 15, works in conjunction with the Presentation Services 23 and other components of the Application Server 11, to provide dynamic content to the web server 5 for delivery to the browser-based Buyer system 3. The Buyer Application component 15 also encodes logic that allows for the respective Buyer to create and manage projects and store information pertaining thereto in the Database 21, which preferably includes access to and/or presentation of offers submitted by Invited Sellers for the projects of the respective Buyer as well as information provided by the Seller related thereto.

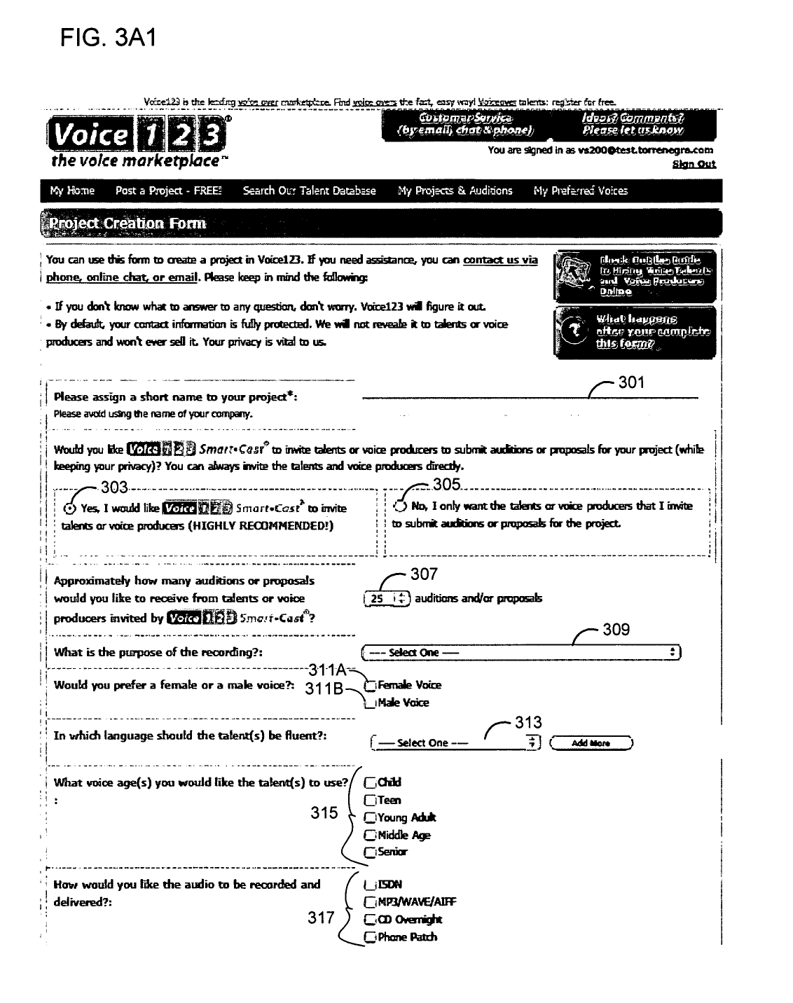

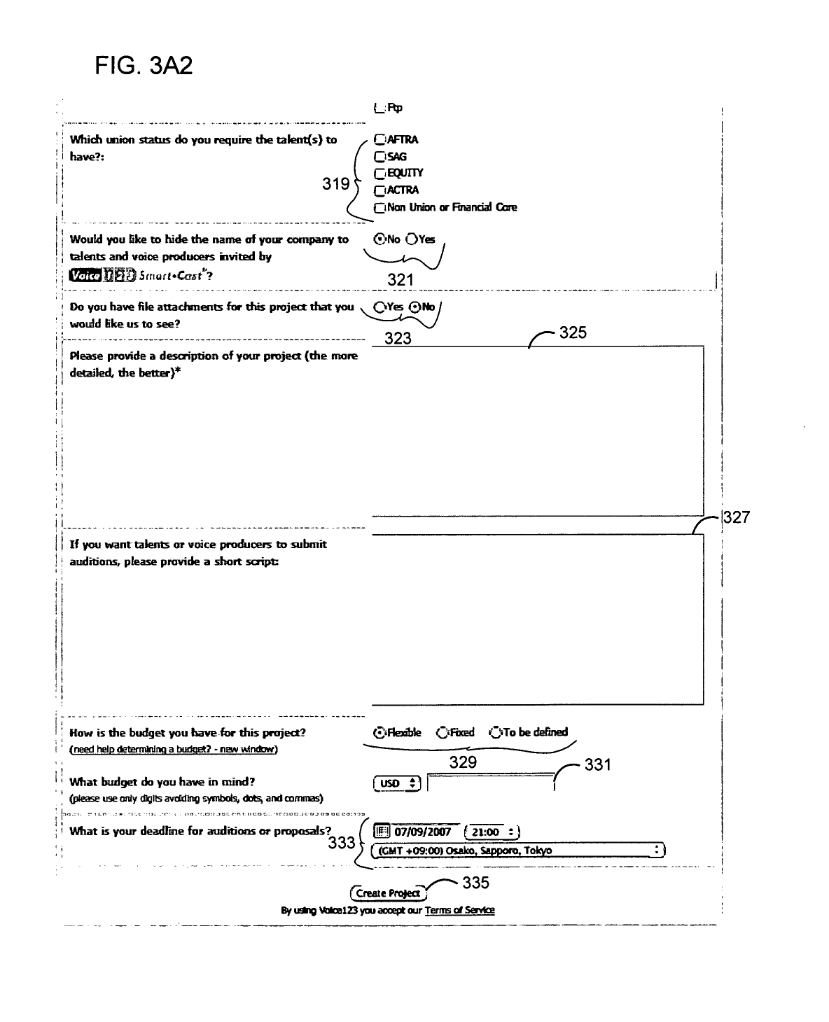

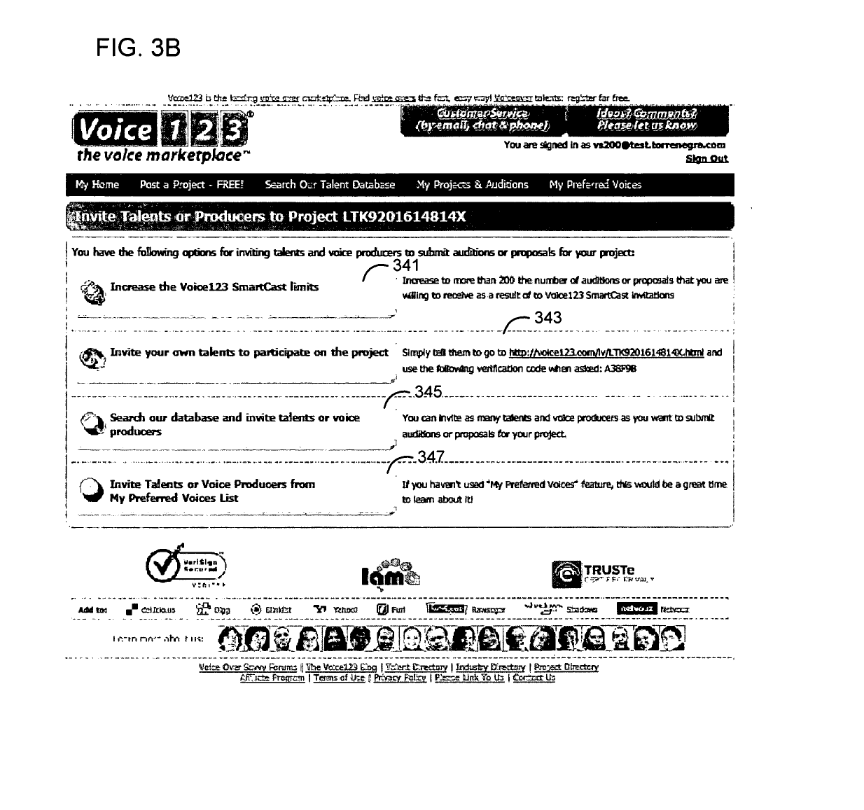

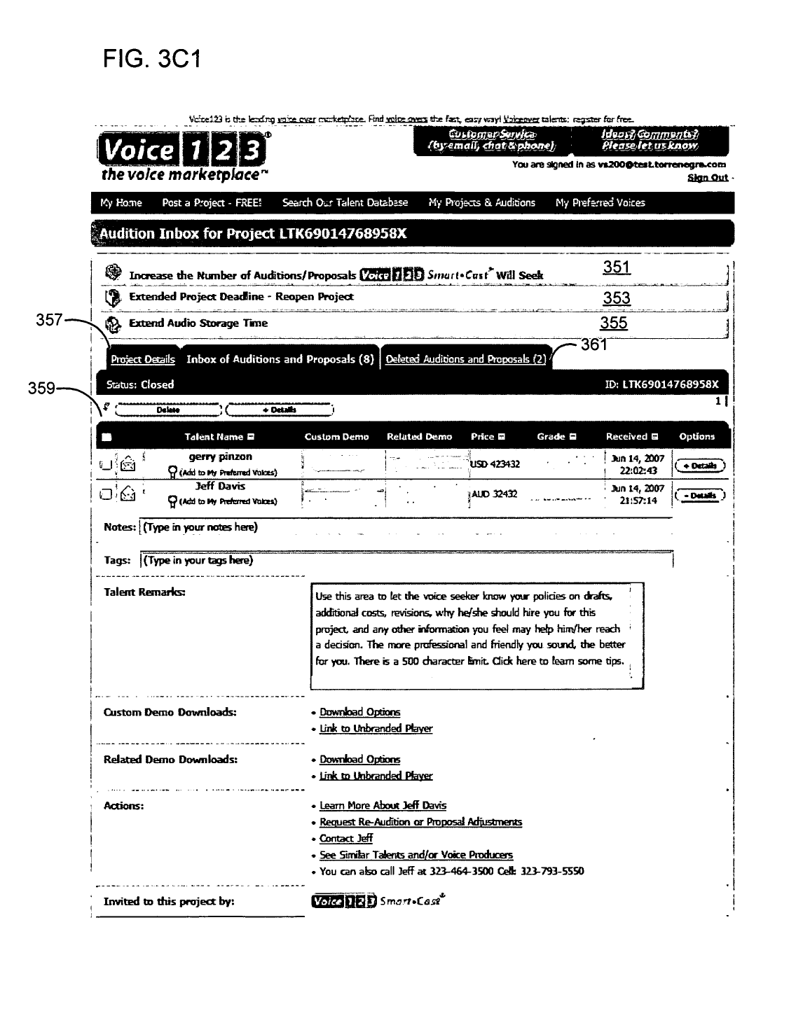

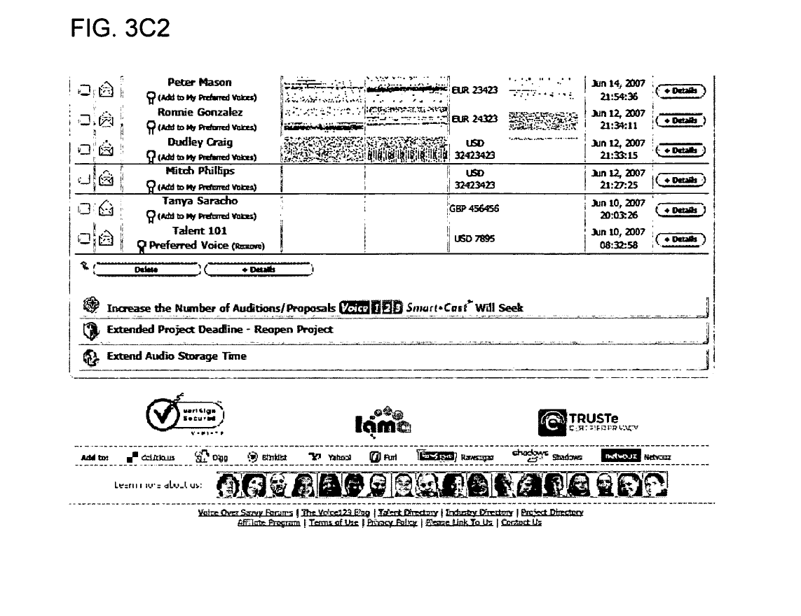

FIGS. 3A1, 3A2 and 3B depict exemplary user interfaces generated by the Buyer Application component 15 for creating and managing projects where voice over talent or producers provide voiceovers to buyers for commercial needs. The user interfaces are communicated to and rendered by the buyer system 3 by operation of a web browser executing on the buyer system 3.

FIGS. 3A1 and 3A2, collectively, illustrate a user interface generated by the Buyer Application component 15 for creating a project, including a text box 301 for assigning a name to the project, buttons 303, 305 for selectively activating and deactivating the Buyer Seller Matching logic 16 described below for the project, a widget 307 for specifying the number of offers that the Buyer would like to receive for the project, a pull down box 309 to enable the Buyer to specify the purpose of the project, buttons 311A, 311B that allows the Buyer to specify a preference for a female or male voice, a pull down menu 313 that allows the Buyer to specify the language fluency requirements for the project, a set of buttons 315 that allows the Buyer to specify the voice age for the project, a set of buttons 317 that allows the Buyer to specify the audio recording format and delivery mechanism for the project, a set of buttons 319 that allows the Buyer to specify any union requirements for the project, buttons 321 that allow the Buyer to selectively hide the name of the Buyer's company to sellers for the project, buttons 323 that allow the Buyer to selectively attach files for the project, a text input box 325 that allows the Buyer to provide a description of the project, a text input box 327 that allows the Buyer to provide a script for an audition for the project, a set of buttons 329 and an input box 531 that allows the Buyer to describe the budget for the project, a date/time input widget 333 that allows the Buyer to define a date and time deadline for the project, and a button 335 that is selected by the Buyer to commit storage of the project data as defined by the user input in the Database 21 of the system.

FIG. 3B illustrates a user interface generated by the Buyer Application component 15 for managing a project, including a selector box 341 that enables the Buyer to navigate to a user interface (not shown) for increasing the number of offers that the Buyer wishes to receive for a project, a display field 343 that enables the Buyer to invite sellers that are not registered in the system to access the project on the system (preferably, such sellers access the project by a project URL and a project access code that is specified in the display field 343), a selector box 345 that enables the Buyer to navigate to a user interface (not shown) for searching for sellers of the system as maintained in the Database 21 and for inviting selected sellers to submit an offer for the project, and a selector box 347 that enables the Buyer to navigate to a user interface (not shown) for inviting sellers that are on the Buyer's Preferred Seller List (as maintained in the Database 21) to submit an offer for the project.

FIGS. 3C1 and 3C2, collectively, illustrate a user interface generated by the Buyer Application component 15 for managing a project, including selector box 351 that enables the Buyer to navigate to a user interface (not shown) for increasing the number of offers that the Buyer wishes to receive for a project, a selector box 353 that enables the Buyer to navigate to a user interface (not shown) for updating the deadline of (or reopening) the project, a selector box 355 that enables the Buyer to navigate to a user interface (not shown) for extending audio storage time for the project, a tabbed folder including a project detail tab 357, an inbox tab 359 that provides the Buyer with access to the offers submitted by Invited Sellers (including the display of status information related to the offers and performing various actions related thereto as shown), and a deleted tab 361 that provides the Buyer with access to offers deleted by the Buyer.

The Buyer Seller Matching Logic 16 works in conjunction with the other components of the Application Server 11 to match a number of Sellers to a given Buyer's project that is posted or otherwise designated by the given Buyer. A Seller is matched to a given Buyer's project by classifying the Seller as an Invited Seller for this project as described below in more detail.

The Seller Application component 17, works in conjunction with the Presentation Services 23 and other components of the Application Server 11, to provide dynamic content to the web server 5 for delivery to the browser-based Seller system 9. The Seller Application component 17 also encodes logic that allows Sellers to create and maintain profiles (short description of goods or services, training, additional skills, experience, description of goods or services, historical price data for projects, desired buyer preferences, project matching filter data, etc.), which are stored in the Database 21. The Seller Application component 17 also enables the Seller to perform various actions with regard to project(s) that are matched to the Seller (such as creation, submission and management of offers related to a given Buyer's project).

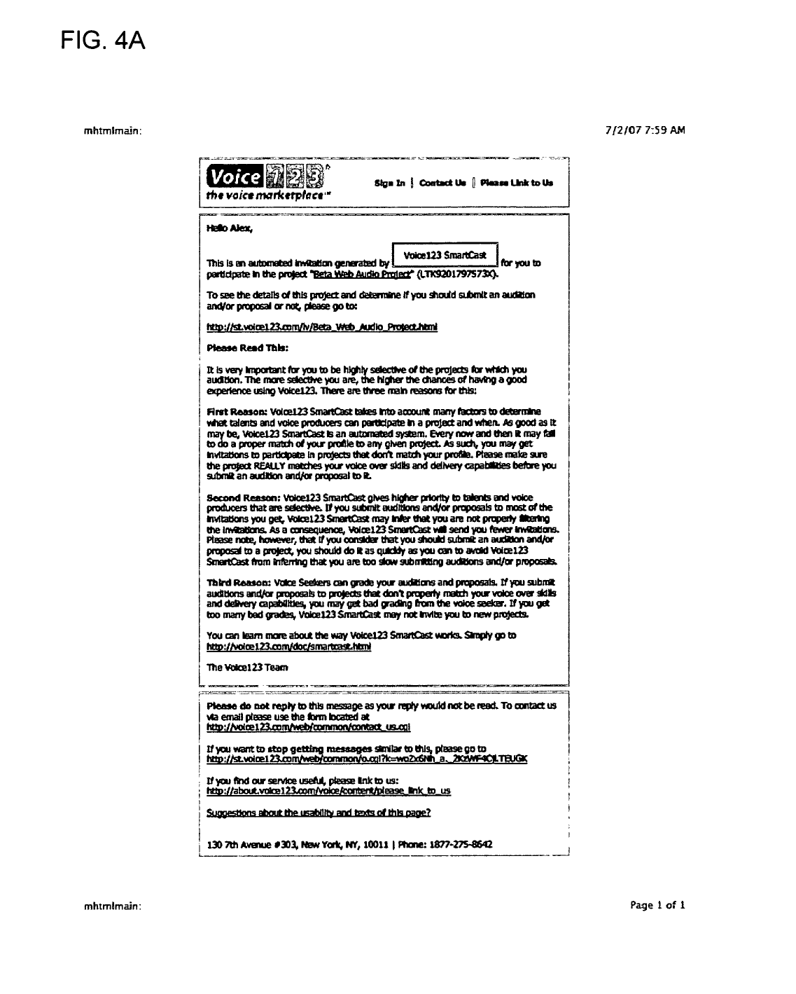

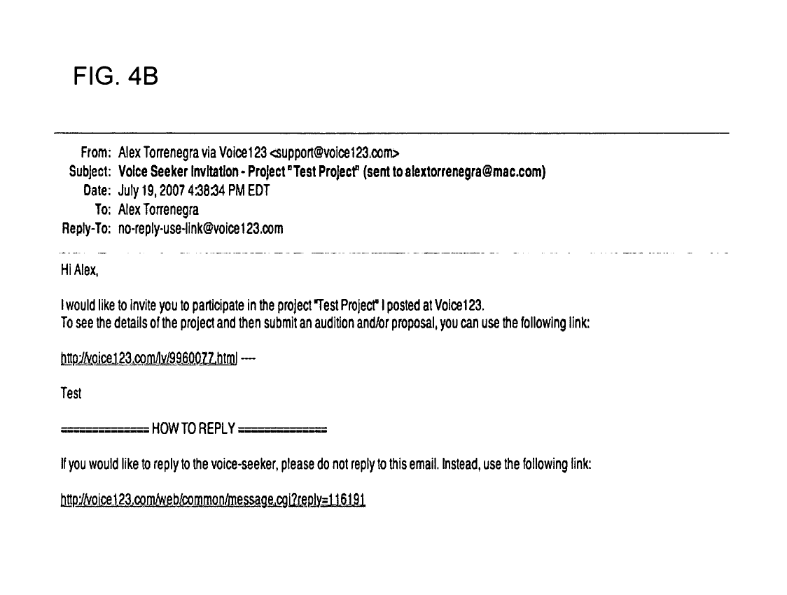

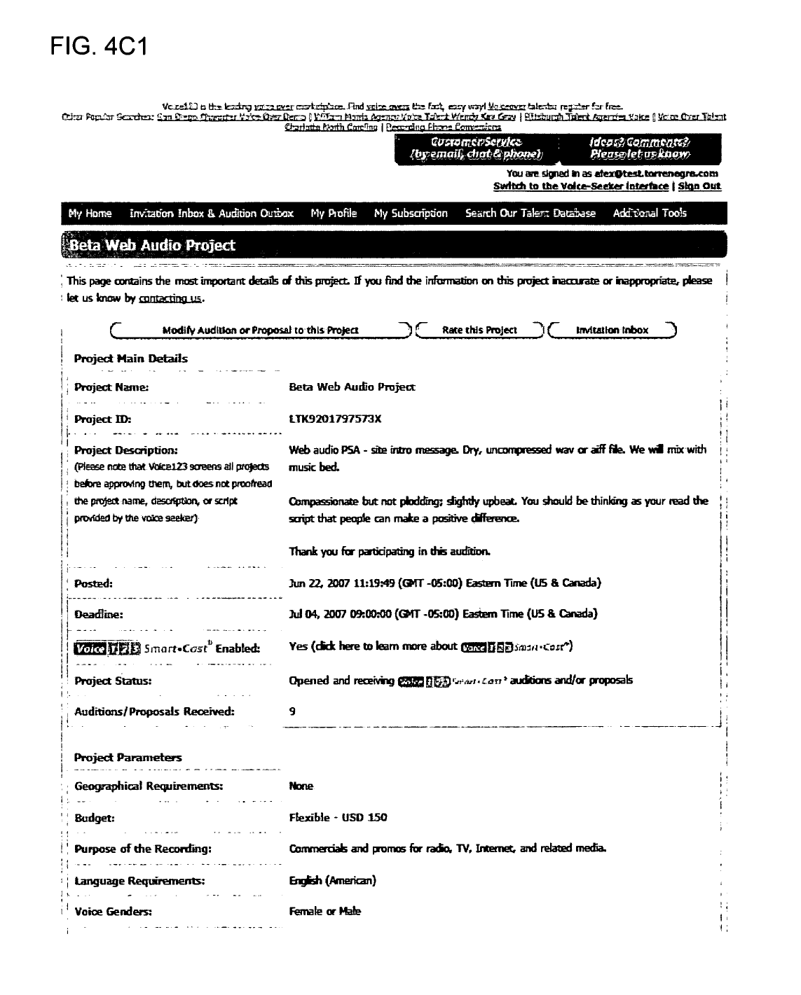

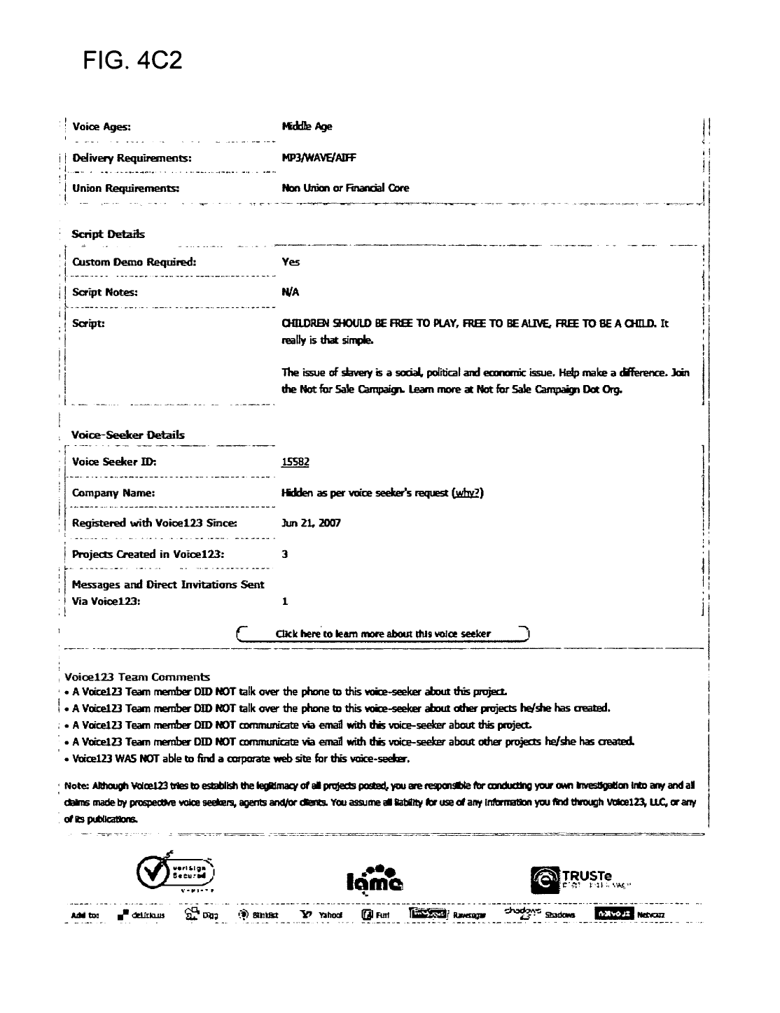

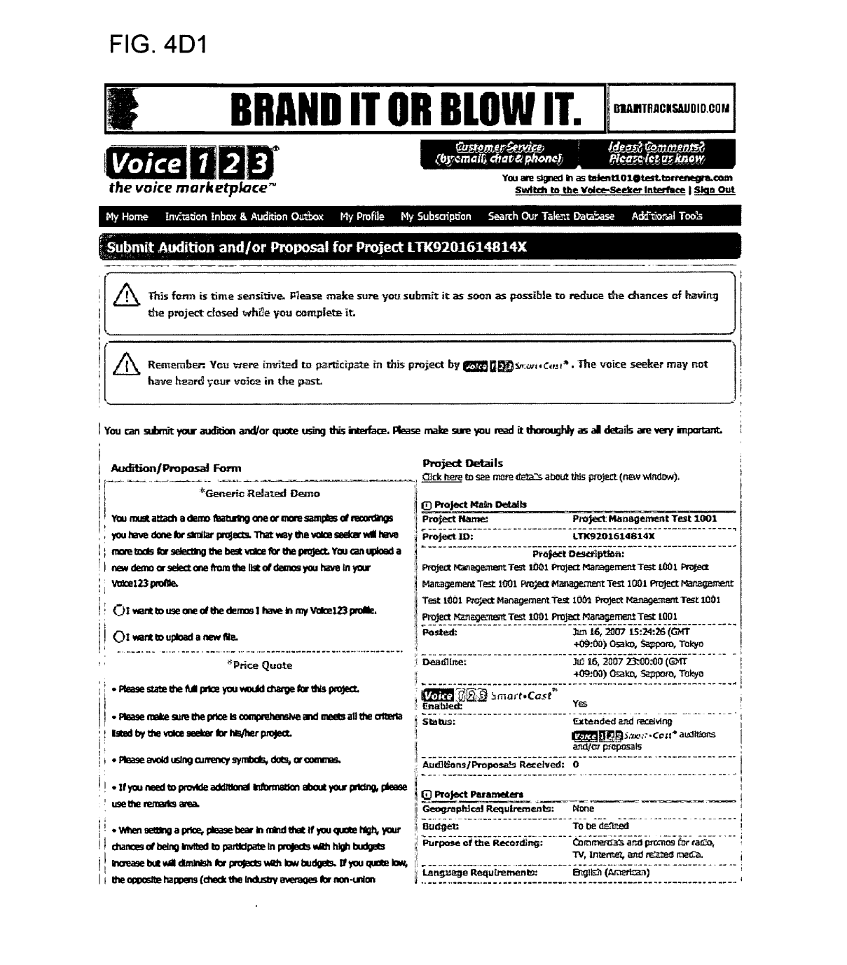

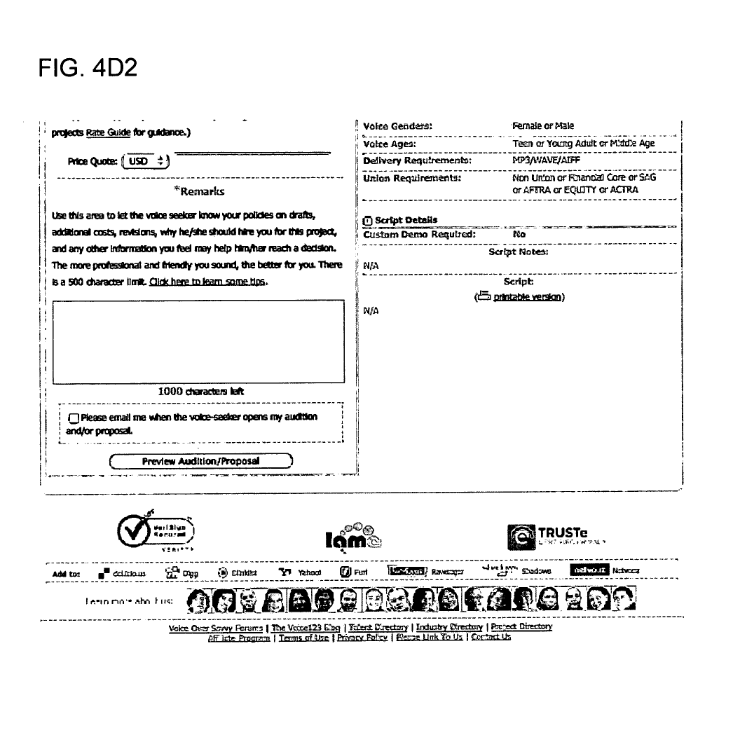

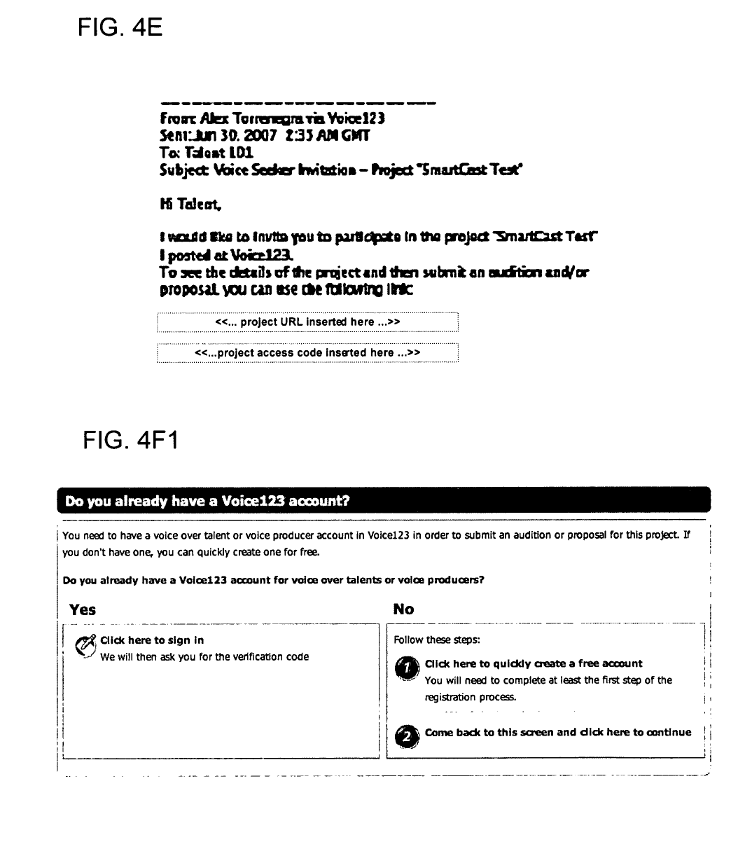

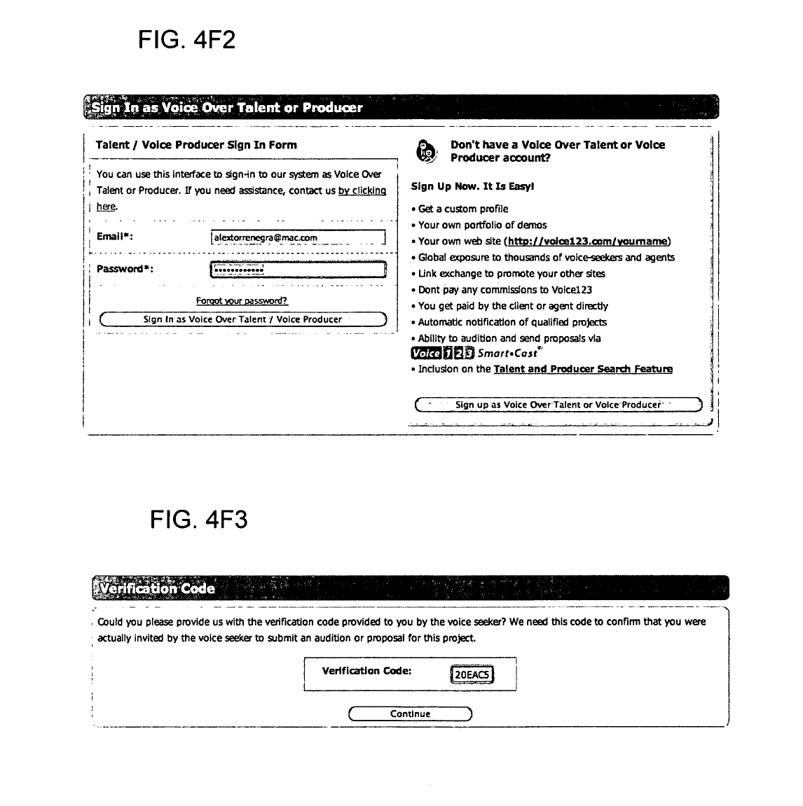

FIGS. 4A, 4B1, 4B2, 4C1, 4C2, and 4D depict exemplary user interfaces generated by the Seller Application component 17 that allows voice over talent or producers (Voice Over Seller) to perform various actions with regard to project(s) that are matched to the Voice Over Seller by the Matching Logic 16. The user interface is communicated to and rendered by the seller system 9 by operation of a web browser executing on the seller system 9. The Database 21 maintains a profile for each Voice Over Seller, which specifies one or more of the following: i) one or more languages that the Voice Over Seller is fluent in, ii) types of projects that the Voice Over Seller is interested in pursing, iii) one or more voice ages that can be provided by the Voice Over Seller, iv) audio format and delivery options provided by the Voice Over Seller, v) one or more union affiliations of the Voice Over Seller, v) a description of the Voice Over Seller's voice, vi) a description of the experience of the Voice Over Seller, vii) training of the Voice Over Seller, viii) additional skills of the Voice Over Seller, ix) contact information for the Voice Over Seller, x) means for initiating payment to the Voice Over Seller, xi) one or more audio files for demonstrating the voice over skills of the Voice Over Seller, xii) historical price data for projects, xiii) desired buyer preferences, and xiv) project matching filter data.

FIG. 4A illustrates a user interface generated by the Seller Application component 17 for notifying a Voice Over Seller that the Voice Over Seller has been matched to a Buyer's project by an automatic matching process carried out as part of the Buyer Seller Matching Logic 16 as described herein. This notification is automatically generated by the system and triggered by the classification of the Voice Over Seller as an Invited Seller as described herein.

FIG. 4B illustrates a user interface generated by the Seller Application component 17 for notifying a Voice Over Seller that the Voice Over Seller has been matched to a Buyer's project by Buyer selection of the Voice Over Seller as part of the processing of the Buyer Seller Matching Logic 16 as described herein. This notification is automatically generated by the system and triggered by the classification of the Voice Over Seller as an Invited Seller as described herein.

FIGS. 4C1 and 4C2, collectively, illustrate a user interface generated by the Seller Application component 17 that allows the Voice Over Seller to view the details of a project that the Voice Over Seller has been matched to. The project details include a description of the project, the date the project was posted, the deadline for the project, project status (opened and receiving offers or closed), how many offers received, geographical requirements for the project, budget information, language requirements for the project, voice gender for the project, voice age for the project, audio recording and delivery requirements for the project, union requirements for the project, script information for the project, voice seeker (Buyer) details for the project, etc.

FIGS. 4D1 and 4D2, collectively, illustrate a user interface generated by the Seller Application component 17 that allows the Voice Over Seller to create and submit an offer for a project that the Voice Over Seller has been matched to. The interface enables the Voice Over Seller to upload an audio file as part of the offer (e.g., for an audition or other demonstration purposes), specify the price of the project, and provide other relevant information as shown. The interface also includes a button that allows the Voice Over Seller to request notification if and when the Buyer of the project opens the offer and/or information related thereto as shown. The interface also provides detailed information regarding the project as shown. This interface is presented to the Voice Over Seller for a given Project only in the case where the Voice Over Seller is classified as an Invited Seller for the given project as described herein.

The Buyer and Seller Application components 15, 17 also include functionality (e.g., a messaging interface) that provides for communication between Buyers and Sellers in order to facilitate transactions therebetween. Messaging logic/services 27 provided by the Application Server 11 can be used to carry out such communication. The Messaging logic/services 27 can support voicemail for voice messages, email messaging, IM messaging, SMS messaging or other suitable communication services between Buyers and Sellers. FIG. 5C illustrates a user interface generated by the Buyer Application component 15 that allows a Buyer to communicate an invitation to submit an offer for a project. Similar interfaces can be used for other communication from the Buyer to a Seller and from a Seller to a Buyer in order to facilitate matching a Seller to a Buyer, for collaboration therebetween on projects, for arranging payment between the Buyer and Seller, etc.

The Buyer can also select one or more Sellers not registered by the system and communicate to such non-registered Sellers invitations for submission of an offer for the given Buyer's project. Such communication can be carried over any one of a number of ways including, but not limited to, email, text messaging, SMS messaging, phone, facsimile, direct conversation, regular mail, bulletin boards, electronic bulletin boards, etc. These invitations preferably include a project URL and an optional project access code as shown in the exemplary email invitation of FIG. 4E. The non-registered Seller(s) use the project URL to access the system to initiate registration of the Seller(s) on the system as shown in the exemplary graphical user interface of FIGS. 4F1 and 4F2. The project access code is used to confirm that the Seller accessing the system was in fact invited by the Buyer as shown in the exemplary graphical user interface of FIG. 4F3. Upon confirmation, the now registered Seller is classified as an Invited Seller for the given Buyer's project and the Seller is granted access to the system for electronic submission of an offer for the Buyer's project and tasks related thereto in a manner similar to that shown in FIGS. 4C1, 4C2, 4D1 and 4D2.

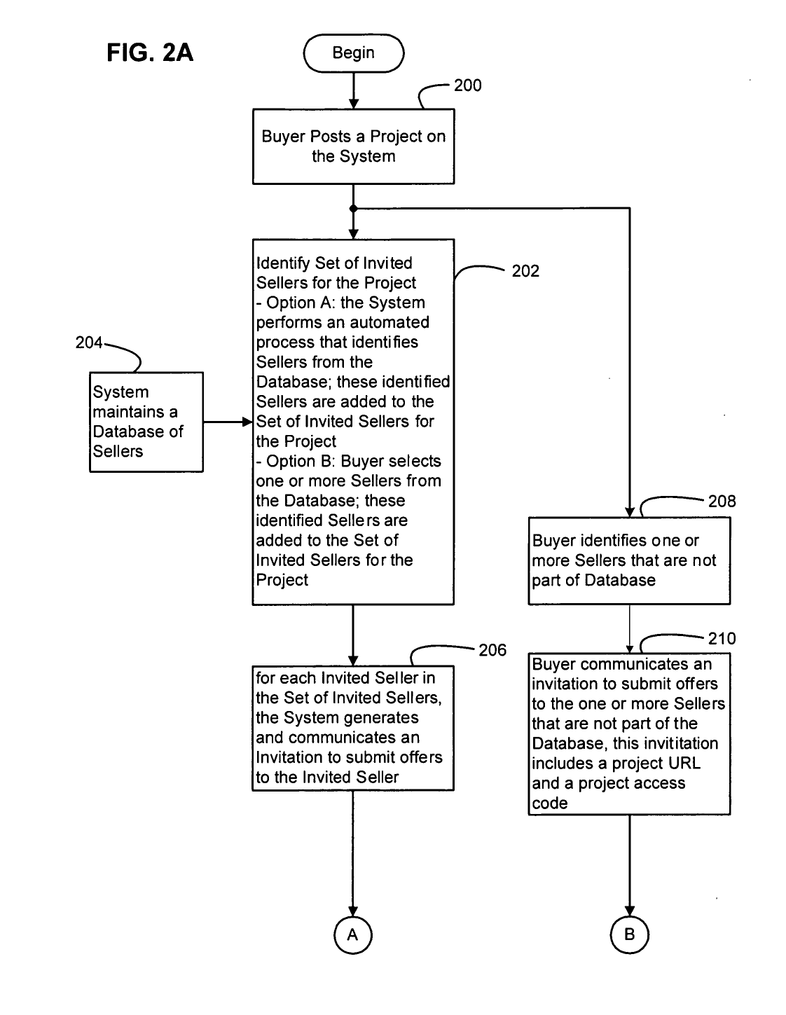

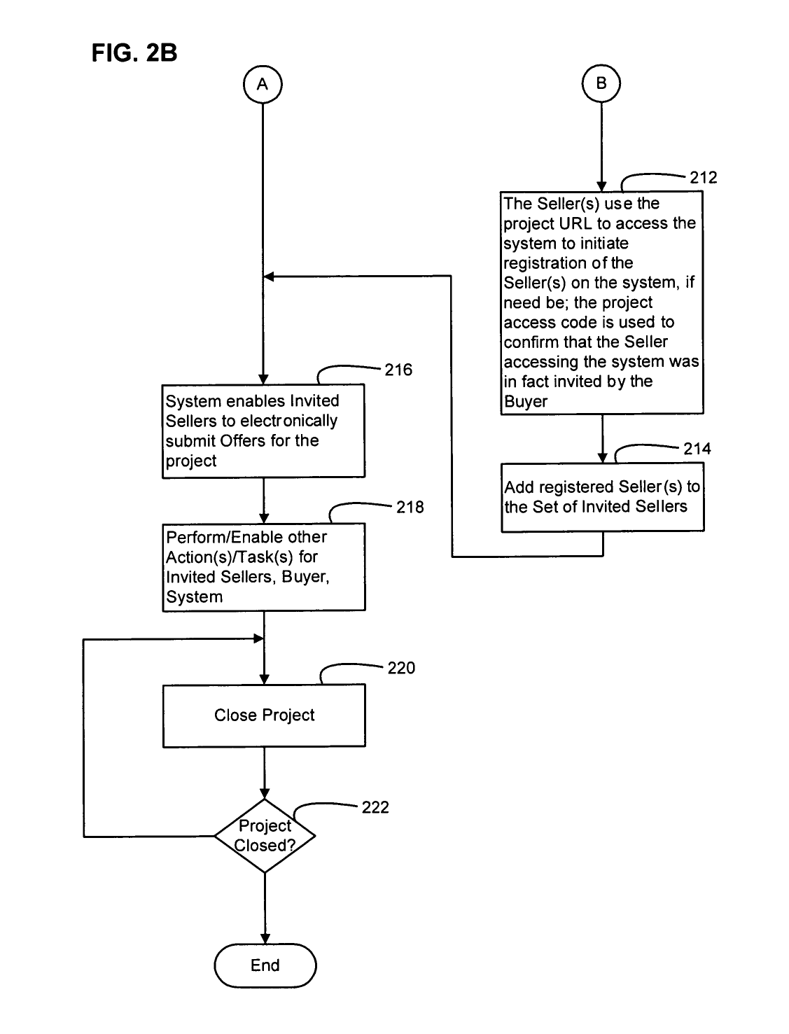

Turning now to FIGS. 2A and 2B, there is shown a high-level schematic representation of the functions provided by the Buyer Seller Matching Logic 16. Such functions begin in block 200 upon a Buyer creating a project (P) on the system (FIGS. 3A1 and 3A2). At block 202, the process presents the Buyer with one or more options as to how Sellers can be invited to submit offers for the project P (FIG. 3B). These options can be presented to the Buyer while the project is being created, before the projected is posted and stored in the Database 21 or anytime after the project has been created (even if offers have been received).

The options presented to the Buyer in block 202 include an Option A whereby the system performs an automatic process that selects registered Sellers from to Database 21 based on the Sellers profiles stored therein (block 204) as matched against the requirements of the project (P) as stored therein. The process classifies these Sellers as “Invited Sellers.” Details of an exemplary embodiment for carrying out this automatic matching process is set forth in U.S. patent application Ser. No. 11/780,553, filed on Jul. 20, 2007, commonly assigned to the assignee of the present invention and incorporated by reference herein in its entirety.

The options presented to the Buyer in block 202 also include an Option B whereby the Buyer selects one or more Sellers from the Database 21. The Sellers presented to the Buyer for selection can be narrowed by search criteria specified by Buyer input. The process also classifies these Buyer selected Sellers as “Invited Sellers.”

In block 206, the process automatically communicates invitations for submission of an offer for the project P to the “Invited Sellers” as identified in block 202. Such invitations are preferably communicated to the “Invited Sellers” as part of an invitation inbox presented to the Invited Sellers by the system (FIG. 4A for the invitations to Invited Sellers of Option A and/or FIG. 4B for the invitations to Invited Sellers of Option B) and possibly over additional communication mechanisms, which include, but are not limited to, email, text messaging, SMS messaging, phone, facsimile, direct conversation, regular mail, bulletin boards, electronic bulletin boards, etc.

In block 202, the process also preferably presents the Buyer with an option C to select one or more Sellers not registered by the system. Such non-registered Sellers are known by the Buyer but not registered as part of the system. In this case, the process preferably displays a project URL and an optional project access code for the project (FIG. 3B). In block 208, the Buyer selects one or more Sellers not registered by the system and communicates externally to such non-registered Sellers invitations for submission of an offer for the given Buyer's project. Such external communication can be carried over any one of a number of ways including, but not limited to, email, text messaging, SMS messaging, phone, facsimile, direct conversation, regular mail, bulletin boards, electronic bulletin boards, etc. The invitations to such non-registered sellers preferably include the project URL and the optional project access code (FIG. 4E). In block 212, the non-registered Seller(s) use the project URL to access the system to initiate registration of the Seller(s) on the system (FIGS. 4F1 and 4F2). The project access code is used to confirm that the Seller accessing the system was in fact invited by the Buyer. In block 214, the process classifies the Seller(s) as an “Invited Seller” upon successful registration.

It is also contemplated that the non-registered sellers can be invited to submit an offer via an electronic message (e.g., email, SMS, IM, etc.) generated by the system. In this case, the Buyer identifies the communication identifier (e.g., an email address) for the non-registered seller in block 208 and the system utilizes this identifier to communicate the invitation to the non-registered seller. In this case, the non-registered seller can be classified as an “Invited Seller” prior to any registration by the non-registered Seller and registration of the non-registered seller (steps 212 and 214) can possibly be avoided. The project URL and project access code are used to provide access to the details of the project and submit offers (block 216).

At block 216, the process enables Invited Sellers to view details of the project P and to electronically submit offers for the project P (FIGS. 4C1, 4C2, 4D1, and 4D2). The details of the project P are specified by the Buyer and stored on the Database 21 by the Buyer Application component 15 and accessed by and/or presented to the Seller by the Seller Application component 17, or possibly communicated to the Invited Seller via external messaging such as telephone, fax, e-mail, SMS, IM, etc. The details of the offer for the project P are specified by the Invited Seller and stored on the Database 21 by the Seller Application component 17 and accessed by and/or presented to the Buyer by the Buyer Application component 15, or possibly communicated to the Buyer via external messaging such as telephone, fax, e-mail, SMS, IM, etc. Such operations enable the Invited Sellers of options A, B and C as discussed above to electronically submit offers for the project P, which are maintained in the Database 21 for access by the Buyer.

At block 218, the process enables the Invited Seller(s), the Buyer ands possibly the system to perform additional tasks related to the project P, for example allowing communication between the Invited Seller(s) and Buyer and possibly additional information exchanges.

At block 220, the process determines if the project P should be closed. Projects can be closed for several reasons. For example, the project can close automatically upon expiration of a predetermined event (e.g., the last processing cycle of the automatic matching process of Option A). In another example, the Buyer can designate a number of offers that the Buyer wants to receive during the process. The system can track the number of offers that the Buyer receives during the process and close the process when the tracked number of received offers matches the number of wanted offers designated by the Buyer. In other examples, the project can be closed when the deadline for receiving offers has passed; the Buyer has already selected a Seller; the Buyer opted to stop receiving offers before the original deadline; etc. If closed, the project could be reopened at any time upon the Buyer's request, thus restarting or reactivating the process.

At block 222, the process determines whether the project (P) has been closed. If the project (P) has not yet closed, the process returns to block 208 to continue the FCP process. If the project has closed, process can automatically perform various system tasks related to the project before it ends. Such system tasks can include:
(1) notification to Invited Seller(s) that the project has closed (which can be accomplished by the mechanisms discussed above);
(2) notification to the Buyer that the project has closed (which can be accomplished by the mechanisms discussed above);
(3) disabling communication between the Invited Seller(s) and Buyer (which can be accomplished by the mechanisms discussed above);
(4) disabling submission of offers and/or information related thereto from the Invited Seller(s) to the Buyer (which can be accomplished by the mechanisms discussed above);
(5) disabling access to detailed information regarding the project by the Invited Seller(s) (which can be accomplished by the mechanisms discussed above); and
(6) disabling exchange of information between the Buyer and the Invited Seller(s) as desired (which can be accomplished by the mechanisms discussed above).

It is also contemplated that other mechanisms can be used to enable a non-registered Seller (Option C) to submit an offer for a project. For example, the invitation to the non-registered Seller can specify a phone number and possibly a project access code. An Interactive Voice Response (IVR) system is accessed by the specified phone number (and access code, if need be) in order to provide details of the project and enable the non-registered Seller to submit an offer for the Project P. The details of the offer are stored in the Database 21 and made accessible to the Buyer as described above. Similarly, the invitation to the non-registered Seller can specify an email address or fax number where the non-registered Seller can access (or begin the access process for) the details of the project and/or submit an offer for the project P.

Advantageously, the system, methodology and apparatus described herein enable sellers to better participate in the electronic commerce system by enabling non-registered sellers to participate in the electronic commerce system. The system, methodology and apparatus also provide different options for buyers to obtain offers for goods and/or services, including options for registered and non-registered sellers of such goods and/or services. Many advantages are thereby recognized, including:
the buyer can easily invite non-registered sellers to submit offers for a project;
the buyer has a better chance at finding the appropriate seller;
the buyer can more easily compare offers submitted by registered sellers with offers from non-registered sellers known by the buyer;
the electronic commerce system provides the opportunity for new sellers, known by a buyer, to become part of the system; and
the electronic commerce system can become an industry standard for processing projects, for managing offers, bids and proposals, and for finding the best seller for a given buyer's project.

There have been described and illustrated herein several embodiments of a system, methodology, and apparatus for facilitating selection of sellers in an electronic commerce system. While particular embodiments of the invention have been described, it is not intended that the invention be limited thereto, as it is intended that the invention be as broad in scope as the art will allow and that the specification be read likewise. Thus, while particular application server architectures have been disclosed, it will be appreciated that other architectures for web-based services can be used as well. In addition, while particular schema and data have been disclosed for matching voice over talent to buyers, it will be understood that the logic, systems and apparatus as described herein can be used for other applications, including, and not by way of limitation, systems for matching employers to potential employees, systems for matching corporate buyers to potential vendors and other suitable reverse auction processes. Moreover, while particular graphical user interface elements have been disclosed, it will be appreciated that other graphical user interface elements can be used as well. It will therefore be appreciated by those skilled in the art that yet other modifications could be made to the provided invention without deviating from its spirit and scope as claimed.

What is claimed is:

1. A method for facilitating a transaction between a buyer and one of a number of sellers utilizing a system that is accessible by the buyer and sellers over a communication network, the transaction related to a project specified by the buyer and maintained in a database of the system, the method comprising:
identifying a set of sellers selected from the group including i) first-type sellers that are registered by the system and selected by an automated process carried out by the system, ii) second-type sellers that are registered by the system and selected by the buyer, and iii) third-type sellers that are not registered by the system and selected by the buyer;
receiving offers from each seller of the set of sellers; and
presenting to the buyer the offers received from the set of sellers.

2. A method according to claim 1, wherein:
the project is a solicitation for goods and/or services that are desired by the buyer.

3. A method according to claim 2, wherein:
a project involves a number of requirements selected from the group including
i) one or more dates related to the project; and
ii) specific needs or functions to be provided by the seller to the buyer.

4. A method according to claim 1, further comprising:
interacting with sellers over the communication network to register and maintain a profile stored the database of the system.

5. A method according to claim 1, further comprising:
interacting with the buyer over the communication network to select whether the first-type sellers are included in the set of sellers.

6. A method according to claim 1, further comprising:
interacting with the buyer over the communication network to select at least one second-type seller from sellers registered by the system.

7. A method according to claim 1, further comprising:
communicating invitations for offer submission to each seller of the set of sellers.

8. A method according to claim 7, further comprising:
interacting with a given seller of the set of sellers over the communication network to present an invitation for offer submission to the given seller.

9. A method according to claim 7, wherein:
the buyer communicates an invitation for offer submission to at least one third-type seller by communication means external to the system.

10. A method according to claim 9, wherein:
the invitation for offer submission communicated to the at least one third-type seller includes a project URL that is utilized by the at least one third-type seller for accessing the system and performing tasks related to the project.

11. A method according to claim 10, wherein:
the invitation for offer submission communicated to the at least one third-type seller includes a project access code that is utilized by the at least one third-type seller for accessing the system and performing tasks related to the project.

12. A method according to claim 1, further comprising:
interacting with at least one seller of the set of sellers over the communication network for electronic submission of a corresponding offer from the at least one seller.

13. A method according to claim 1, further comprising:
storing details of offers in the database of the system.

14. A method according to claim 13, further comprising:
interacting with the buyer over the communication network to present the details of offers stored in the database of the system.

15. A method according to claim 1, wherein:
the first-type sellers are identified by an automated process that matches requirements of the project as specified by the buyer to profile data of sellers.

16. A system for facilitating a transaction between a buyer and one of a number of sellers, the transaction related to a project, the system comprising:
means for interacting with a buyer over a communication network to specify a project and storing data related to the project in a database;
logic that identifies a set of sellers selected from the group including i) first-type sellers that are registered by the system and selected by an automated process carried out by the system, ii) second-type sellers that are registered by the system and selected by the buyer, and iii) third-type sellers that are not registered by the system and selected by the buyer;
means for receiving offers from each seller of the set of sellers; and
means for presenting to the buyer the offers received from the set of sellers.

17. A system according to claim 16, wherein:
the project is a solicitation for goods and/or services that are desired by the buyer.

18. A system according to claim 17, wherein:
a project involves a number of requirements selected from the group including
i) one or more dates related to the project; and
ii) specific needs or functions to be provided by the seller to the buyer;

19. A system according to claim 16, further comprising:
means for interacting with sellers over the communication network to register and maintain a profile stored the database of the system.

20. A system according to claim 16, further comprising:
means for interacting with the buyer over the communication network to select whether the first-type sellers are included in the set of sellers.

21. A system according to claim 16, further comprising:
means for interacting with the buyer over the communication network to select at least one second-type seller from sellers registered by the system.

22. A system according to claim 16, further comprising:
means for communicating invitations for offer submission to at least one seller of the set of sellers.

23. A system according to claim 22, further comprising:
means for interacting with a given seller of the set of sellers over the communication network to present an invitation for offer submission to the given seller.

24. A system according to claim 22, wherein:
the buyer communicates an invitation for offer submission to at least one third-type seller by communication means external to the system.

25. A system according to claim 24, wherein:
the invitation for offer submission communicated to the at least one third-type seller includes a project URL that is utilized by the at least one third-type seller for accessing the system and performing tasks related to the project.

26. A system according to claim 25, wherein:
the invitation for offer submission communicated to the at least one third-type seller includes a project access code that is utilized by the at least one third-type seller for accessing the system and performing tasks related to the project.

27. A system according to claim 16, further comprising:
means for interacting with at least one seller of the set of sellers over the communication network for electronic submission of a corresponding offer from the at least one seller.

28. A system according to claim 16, further comprising:
means for storing details of offers in the database of the system.

29. A system according to claim 28, further comprising:
means for interacting with the buyer over the communication network to present the details of offers stored in the database of the system.

30. A system according to claim 16, further comprising:
software logic that identifies the first-type sellers, the software logic including an automated process that matches requirements of the project as specified by the buyer to profile data of sellers.

31. An application server, operably coupled to the Internet, for facilitating a transaction between a buyer and one of a number of sellers, the transaction related to a project, the application server comprising:
a database;
means for interacting with a buyer over a communication network to specify a project and storing data related to the project in the database;
means for identifying a set of sellers selected from the group including i) first-type sellers that are registered by the system and selected by an automated process carried out by the system, ii) second-type sellers that are registered by the system and selected by the buyer, and iii) third-type sellers that are not registered by the system and selected by the buyer;
means for interacting with sellers over the communication network to receiving offers from each seller of the set of sellers; and
logic for interacting with the buyer over the communication network for presenting to the buyer the offers received from the set of sellers.
